(19) United States
(12) Patent Application Publication
(10) Pub. No.: US 2022/0369853 A1
(43) Pub. Date: Nov. 24, 2022

(54) CONTROL METHOD FOR CONTROLLING THE CURRENT DISPENSING CYCLE OF A COFFEE MACHINE

(71) Applicant: DE'LONGHI APPLIANCES S.R.L., Treviso (IT)

(72) Inventor: Ivano GENTILI, Treviso (IT)

(73) Assignee: DE' LONGHI APPLIANCES S.R.L., Treviso (IT)

(21) Appl. No.: 17/633,314

(22) PCT Filed: Jul. 6, 2020
(86) PCT No.: PCT/EP2020/068965

§ 371 Date: Feb. 7, 2022

(30) Foreign Application Priority Data
Aug. 8, 2019 (IT) 102019000014463

(51) Int. Cl. A47J 31/52; A47J 31/40; A47J 31/46; A23F 5/26

(52) U.S. Cl. CPC A47J 31/52; A47J 31/404; A47J 31/468; A23F 5/26

(57) ABSTRACT

The control method for controlling the current dispensing cycle of a coffee machine comprising an electronic controller, a brewing pump and a brewing unit having a housing chamber of an amount of coffee powder, in which the current dispensing cycle comprises a dispensing step and a possible preliminary step of wetting the amount of coffee powder in which there is no dispensing, provides that the electronic controller controls the dispensing speed of the entire dispensing step of the current dispensing cycle by dividing the brewing pump by a control algorithm that acquires a parameter calculated from stored dispensing data of dispensing steps of dispensing cycles preceding the current dispensing cycle exclusively.

### CROSS-REFERENCE TO RELATED APPLICATIONS

This is a U.S. national phase application under 35 U.S.C. § 371 of International Patent Application No. PCT/EP2020/068965, filed Jul. 6, 2020, and claims benefit of priority to Italian Patent Application No. 102019000014463, filed Aug. 8, 2019. The entire contents of these applications are hereby incorporated by reference.

### TECHNICAL FIELD

The present invention relates to a control method for controlling the current dispensing cycle of a coffee machine and a coffee machine implementing said method.

### BACKGROUND

In particular, the present control method is applied in coffee machines comprising a brewing pump and an electronic controller controlling said brewing pump.

The organoleptic qualities of a coffee-based beverage depend substantially on how the dispensing cycle is executed, with particular regard to the brewing of the coffee powder.

In particular, the dispensing speed of the beverage itself has a great impact on the organoleptic qualities of the extraction.

The optimal extraction cycle of a coffee machine depends on the type of coffee-based beverage, such as espresso, both short and long, or American coffee, the grain size of the coffee powder used, the type of coffee used, and the state of degradation of the machine itself.

Some control methods for controlling the current dispensing cycle of a coffee machine are known in the state of the art, based on dividing the brewing pump for brewing the coffee powder with hot water at periodic intervals, in which each periodic interval comprises a pump activation period and a pump deactivation period.

Some of these current dispensing control methods are based on a division of the brewing pump pre-set in the coffee machine before being made available for sale. In this case, in a disadvantageous way, the extraction of the coffee beverage is not optimised with respect to the different types of brewing, grain size and coffee used, nor with respect to the state of degradation of the operation of the coffee machine.

Other control methods, on the other hand, are based on a division of the brewing pump in which some brewing parameters are acquired during the first part of the dispensing step and are processed to optimize the second part of the dispensing step.

Therefore, these latter control methods do not allow an optimization of the entire dispensing step, as it is disadvantageously necessary to spend the first part of the dispensing step optimising the second part of the dispensing step.

Consequently, if the dispensing step is very short, only a small part of it is carried out optimally.

### SUMMARY

An object of the present invention is to provide a control method for controlling the current dispensing cycle of a coffee machine which solves the aforementioned problems of the prior art, in particular which allows an optimal extraction of a coffee-based beverage for the duration of the dispensing step.

A further object of the present invention is to provide a control method for controlling the current dispensing cycle with improved performance with respect to that which is known in the state of the art.

Another object of the present invention is to provide a control method for controlling the current dispensing cycle that allows an optimized dispensing of a coffee-based beverage regardless of the type of beverage, the type of grain size of the coffee powder, and the state of wear of the coffee machine used.

A still further object of the present invention is to provide a control method for controlling the current dispensing cycle that allows an optimised dispensing of a coffee-based beverage regardless of environmental variations.

Not least, an object of the present invention is also to provide a coffee machine capable of providing an improved dispensing quality with respect to that which is known in the state of the art.

The technical task, as well as these and other objects, are achieved according to the present invention by providing a control method for controlling the current dispensing cycle of a coffee machine comprising an electronic controller, a brewing pump and a brewing unit having a housing chamber of an amount of coffee powder, in which the current dispensing cycle comprises a dispensing step and a possible preliminary step of wetting said amount of coffee powder in which there is no dispensing, characterized in that the electronic controller controls the dispensing speed of the entire dispensing step of the current dispensing cycle by dividing said brewing pump by a control algorithm that acquires a parameter calculated from stored dispensing data of dispensing steps of dispensing cycles preceding the current dispensing cycle exclusively.

In particular, by means of the control algorithm, the controller is able to conform the dispensing speed over time to an optimal reference profile. Preferably, the control algorithm also acquires a piece of data representative of the amount of coffee powder used for executing the current brewing cycle.

Advantageously, if a wetting step is provided, the control algorithm also acquires a piece of data representative of the type of wetting used for executing the current brewing cycle.

Advantageously, the control algorithm for dividing the brewing pump calculates at least one of the parameters of a periodic control function.

In particular, the parameters of the control function comprise at least one activation time value in a period of said function.

Preferably, the period of said function comprises a sole continuous activation time and a sole continuous deactivation time.

Preferably, the continuous activation time corresponds to an activation at rated power of the brewing pump.

Preferably, once the type of preliminary wetting step and the amount of coffee powder for the current dispensing cycle are determined, the pump activation time in the current dispensing cycle is directly proportional to the amount of coffee powder of the beverage in the current dispensing cycle and inversely proportional to the average dispensing speed of preceding dispensing cycles weighed on the basis of the division thereof, said preceding dispensing cycles relating to the same type of wetting and to the same amount of powder as the current dispensing cycle.

Other characteristics of the present invention are also defined in the following claims.

### BRIEF DESCRIPTION OF THE DRAWINGS

Further characteristics and advantages of the invention will more fully emerge from the description of a preferred but not exclusive embodiment of the control method and an automatic coffee machine, illustrated by way of non-limiting example in the accompanying drawings, in which:

FIG. 1 shows a flow chart of the control method according to the present invention; and

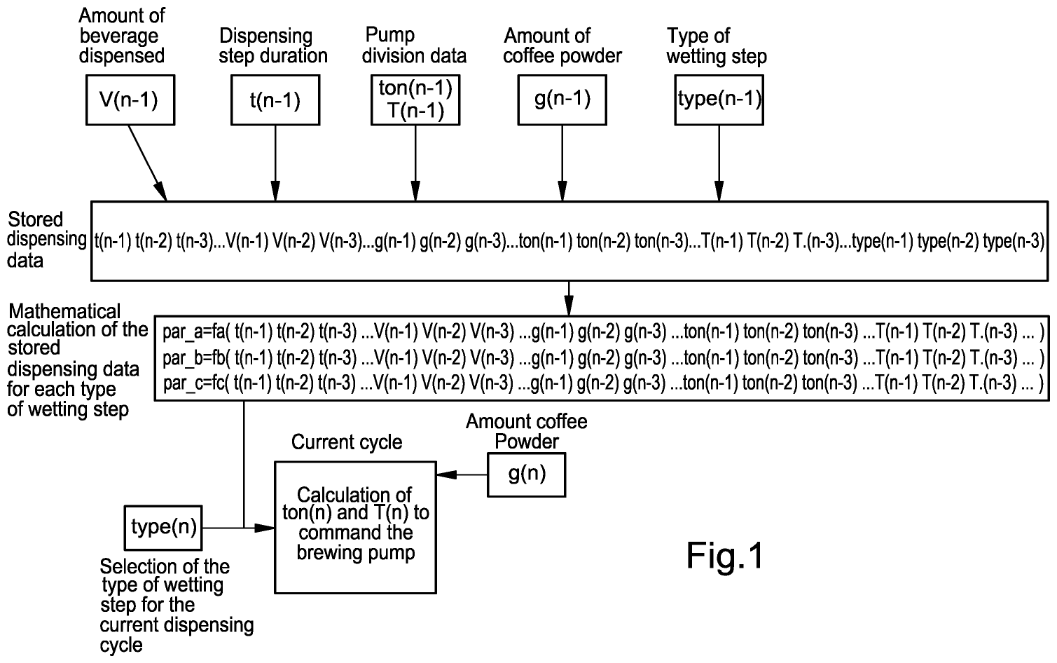

FIG. 2 shows a graph of the division of the flow rate of the pump according to the present invention.

### DETAILED DESCRIPTION

The present invention relates to a control method for controlling the current dispensing cycle of a coffee machine comprising an electronic controller, a brewing pump and a brewing unit having a housing chamber of an amount of coffee powder.

In particular, the current dispensing cycle comprises a dispensing step and a possible preliminary wetting step of the amount of coffee powder in which there is no dispensing.

One type of wetting step may provide for the recompression of the coffee powder after the wetting and a wait time before the start of the dispensing step, another type of wetting step may not provide for the recompression.

According to the present control method, the electronic controller controls the dispensing speed of the entire dispensing step of the current dispensing cycle.

The electronic controller controls said speed by dividing the brewing pump by a control algorithm.

Thanks to the division of the pump, the dispensing speed of the beverage is maintained at a set point value or in a predetermined neighborhood of the set point value.

Division of the brewing pump is intended as the fact of intermittently driving the pump by implementing a periodic cycle of pump activation times followed by pump deactivation times.

In particular, the control algorithm acquires a parameter calculated from stored dispensing data of dispensing steps of dispensing cycles preceding the current dispensing cycle exclusively.

Advantageously, according to the present method it is possible to divide the brewing pump without resorting to a preliminary operation of acquiring the brewing parameters during the current dispensing step.

The division of the brewing pump is based on a history of stored dispensing data of cycles performed by the coffee machine previously, but not only.

Preferably, in fact, the algorithm also acquires a piece of data representative of the amount of coffee powder used for executing the current brewing cycle.

Even more preferably, the control algorithm also acquires a piece of data representative of the type of wetting step used, if provided, for executing the current brewing cycle.

In this way, the controller controls the dispensing speed of the entire dispensing step of the current dispensing cycle, not only on the basis of dispensing data of preceding dispensing cycles, but also in a preferred way based on the current amount of coffee powder used and, if provided, on the type of wetting step used in the current dispensing cycle.

According to a preferred embodiment, if a plurality of types of usable wetting steps are provided, said stored dispensing data are differentiated based on the type of wetting step used.

This differentiation of stored data allows greater precision in pump division. According to a preferred embodiment, the electronic controller calculates said parameter which is acquired by the algorithm for the pump division.

Preferably, if a plurality of usable wetting step types are provided, the controller calculates a differentiated parameter for each usable wetting step type and each calculated parameter is stored for a subsequent selective acquisition by the algorithm.

In this case, the electronic controller controls the dispensing speed by dividing the brewing pump using the control algorithm that has acquired the amount of coffee powder, the type of wetting step and the parameter corresponding to the type of wetting step.

In a preferred embodiment of the invention, the control algorithm for dividing the brewing pump calculates parameters of a periodic control function comprising at least one activation time value in the period and optionally also a value of the period of this control function which may alternatively be selected.

In particular, the period of this control function comprises a sole continuous activation time and a sole continuous deactivation time. In more detail, the continuous activation time corresponds to an activation at rated power of the brewing pump.

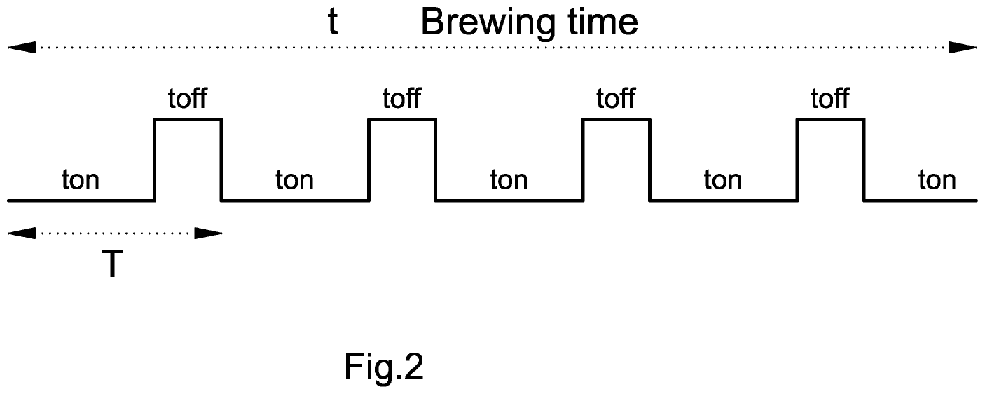

Thus, as shown in FIG. 2, the division of the brewing pump is preferably achieved by a square wave function.

The stored dispensing data can be a plurality of data and the greater the number of data per preceding dispensing cycle, the greater the optimization of the dispensing speed of the current dispensing cycle. In particular, such stored dispensing data are acquired during a plurality of current dispensing cycles.

However, it should be noted that it is not necessary to store the dispensing data of all preceding dispensing cycles.

In fact, the data of a plurality of preceding dispensings may be sufficient to obtain an efficient optimization of the dispensing speed, since the calculated parameter is the result of a statistical calculation.

In particular, the parameter is recalculated at each new dispensing cycle by a mathematical function including simple averages and/or weighted averages and/or accumulators and/or moving averages.

Preferably, the stored dispensing data comprise the duration of the dispensing step of said preceding dispensing cycles.

More preferably, the stored dispensing data comprise the amount of product dispensed in said preceding dispensing cycles.

Even more preferably, said stored dispensing data comprise the amount of coffee powder used in said preceding dispensing cycles.

And still preferably, said stored dispensing data comprise said parameters of said control function calculated in said preceding dispensing cycles.

The present invention further comprises a coffee machine comprising an electronic controller provided with a non-volatile memory unit, a brewing pump, a brewing unit having a housing chamber of an amount of coffee powder.

The non-volatile memory is configured to store dispensing data of dispensing steps of dispensing cycles preceding a current dispensing cycle and a control algorithm.

The electronic controller is configured to control by keeping at a set point value or in a predetermined neighbourhood thereof the dispensing speed of the entire dispensing step of said current dispensing cycle by dividing said brewing pump by said control algorithm that acquires a parameter calculated from said stored dispensing data of dispensing steps of dispensing cycles exclusively preceding said current dispensing cycle.

### Example I

The following stored dispensing data are present on a non-volatile memory:

| | | Amount | Amount | Pump | |
|---|---|---|---|---|---|
| Dispens- | Dispensing | of | of | activation time | Pump |
| ing | step | beverage | coffee | in the division | division |
| cycle | duration | dispensed | powder | period | period |
| n-1 | tₙ₋₁ | Vₙ₋₁ | gₙ₋₁ | tonₙ₋₁ | Tₙ₋₁ |
| n-2 | tₙ₋₂ | Vₙ₋₂ | gₙ₋₂ | tonₙ₋₂ | Tₙ₋₂ |
| n-3 | tₙ₋₃ | Vₙ₋₃ | gₙ₋₃ | tonₙ₋₃ | Tₙ₋₃ |

Before the dispensing cycle n, the controller calculates a parameter par(n) for dividing said pump.

Par(n)=f(tₙ₋₁,tₙ₋₂,tₙ₋₃,Vₙ₋₁,Vₙ₋₂,Vₙ₋₃,gₙ₋₁,gₙ₋₂,gₙ₋₃,tonₙ₋₁,tonₙ₋₂,tonₙ₋₃,Tₙ₋₁,Tₙ₋₂,Tₙ₋₃).

The algorithm acquires a piece of data on the amount of coffee powder used for the current dispensing cycle, g(n).
The algorithm calculates the pump division parameters, generating tonₙ=kₜ(g(n); Par(n)) and Tₙ=k_{T}(g(n); Par(n))

To obtain the value of the dispensing speed for the current dispensing cycle, as close as possible to the defined set point value, the controller commands the brewing pump with said division parameters generated by the algorithm.

### Example II

FIG. 2 shows the case in which a plurality of types of wetting steps a, b and c are executable. (type=a, b, c).
Before the dispensing cycle n, the controller calculates a parameter for dividing said pump for each type of wetting.

Parₐ(n)=f(tₙ₋₁,tₙ₋₂,tₙ₋₃,Vₙ₋₁,Vₙ₋₂,Vₙ₋₃,gₙ₋₁,gₙ₋₂,gₙ₋₃,tonₙ₋₁,tonₙ₋₂,tonₙ₋₃,Tₙ₋₁,Tₙ₋₂,Tₙ₋₃)

Par_{b}(n)=f(tₙ₋₁,tₙ₋₂,tₙ₋₃,Vₙ₋₁,Vₙ₋₂,Vₙ₋₃,gₙ₋₁,gₙ₋₂,gₙ₋₃,tonₙ₋₁,tonₙ₋₂,tonₙ₋₃,Tₙ₋₁,Tₙ₋₂,Tₙ₋₃)

Par_{c}(n)=f(tₙ₋₁,tₙ₋₂,tₙ₋₃,Vₙ₋₁,Vₙ₋₂,Vₙ₋₃,gₙ₋₁,gₙ₋₂,gₙ₋₃,tonₙ₋₁,tonₙ₋₂,tonₙ₋₃,Tₙ₋₁,Tₙ₋₂,Tₙ₋₃)

In this case, the algorithm:

acquires a piece of data on the amount of coffee powder used for the current dispensing cycle, g(n);

acquires a piece of data representative of the type of preliminary wetting step for the current dispensing cycle type (n), e.g. type(n)=b; and

calculates the pump division generating:

tonₙ=k_{tb}(g(n);Par_{b}(n)) and Tₙ=k_{Tb}(g(n);Par_{b}(n))

The controller commands the brewing pump with said division parameters generated by the algorithm.

### Example with Control Algorithm

The pump division algorithm aims to maintain a set point value of the dispensing speed (expressed in cc per second) constant within a given optimal range.

The algorithm uses the following parameters previously acquired in the preceding “n−1” dispensing cycles:

Pump activation time tonᵢ

Pump driving period Tᵢ

Duration of beverage brewing tᵢ

Amount of beverage dispensed in the brewing vᵢ

Amount gᵢ of coffee powder in the beverage

Type of wetting of the coffee powder (A, B, C, D, etc.)

Where i=1 . . . n−1
And uses the following parameters related to the current dispensing cycle:

Type of wetting of the coffee powder for the beverage being executed (A, B, C, D, etc.)

Amount of coffee powder in the beverage being executed gₙ

The starting data of the algorithm for the first dispensings are based on data preloaded in the factory.

Based on these data and those subsequently saved during the dispensings, the algorithm chooses the correct value of tonₙ and Tₙ, or only tonₙ if Tₙ is selected. Assuming that T. is selected, for the beverage being executed ton. will have proportionality:

Direct with regard to the coffee powder of the beverage “n” being executed. The greater amount of powder in the beverage that is about to be dispensed, the greater the ton, will be and vice versa. See the dispensings #4, #23 and #16 in the table below as an example.

Direct with regard to the period Tₙ selected for the beverage “n” being executed. The longer the period Tₙ, the greater tonₙ, will be. See the dispensings #26, #28 or #23, #24 in the table below as an example.

Opposite to the average dispensing speed of the previous “n−1” beverages (weighed according to their division) relating to the same type of wetting (A, B, C, or D) and with the same amount of powder (where the dispensing speed of the beverage is intended as the ratio between the amount of beverage dispensed in the brewing time [cc/s]). If the average dispensing speed of the preceding beverages is greater than the desired dispensing speed set point value, the tonₙ/Tₙ ratio of the beverage being executed will be lowered compared to the average ton/T ratio of the preceding beverages; if the average dispensing speed of the preceding beverages is lower than the set point value, the ton, of the beverage being executed will be raised compared to the tonᵢ of the preceding beverages. See for example the dispensings #5, #6, #7 in the table below by way of example, where the assumption that the algorithm only works on the preceding dispensing cycle was made for simplicity.

Example data for the pump division algorithm

| | Dispensing | | | Dispensing | Current | |
|---|---|---|---|---|---|---|
| | Pump | | Preceding | input the | dispensing | |
| | activation | Output | cycle (on | same type of | cycle | |
| | time in the | Pump | previous | wetting) | input: pre- | |
| | driving | driving | lines with | Amount of | dispensing | |
| | period | period | Brewing | beverage | Amount of | |
| | [hundredths | [hundredths | duration | dispensed | powder | Type of |
| | of s] | of s] | [s] | [cc] | [g] | wetting |
| Factory preloaded A | 100 | 100 | 7.8 | 40.0 | 9.0 | A |
| Factory preloaded B | 100 | 100 | 7.9 | 40.0 | 9.0 | B |
| Factory preloaded C | 100 | 100 | 8.4 | 40.0 | 9.0 | C |
| Factory preloaded D | 100 | 100 | 9.3 | 40.0 | 9.0 | D |
| Dispensing 1 | 100 | 100 | 8.2 | 42 | 9 | A |
| Dispensing 2 | 60 | 100 | 13.7 | 42 | 9 | A |
| Dispensing 3 | 100 | 100 | 7.6 | 38 | 9 | B |
| Dispensing 4 | 60 | 100 | 13.9 | 42 | 9 | B |
| Dispensing 5 | 100 | 100 | 8.6 | 41 | 9 | C |
| Dispensing 6 | 60 | 100 | 15.1 | 43 | 9 | C |
| Dispensing 7 | 65 | 100 | 13.3 | 41 | 9 | C |
| Dispensing 8 | 100 | 100 | 8.6 | 37 | 9 | D |
| Dispensing 9 | 58 | 100 | 12.8 | 38 | 9 | A |
| Dispensing 10 | 70 | 100 | 14.0 | 42 | 9 | D |
| Dispensing 11 | 59 | 100 | 12.9 | 39 | 9 | A |
| Dispensing 12 | 59 | 100 | 12.5 | 37 | 9 | B |
| Dispensing 13 | 60 | 100 | 13.6 | 41 | 9 | B |
| Dispensing 14 | 65 | 100 | 13.3 | 41 | 9 | C |
| Dispensing 15 | 59 | 100 | 12.3 | 37 | 9 | A |
| Dispensing 16 | 50 | 100 | 14.6 | 43 | 5 | B |
| Dispensing 17 | 52 | 100 | 12.0 | 37 | 5 | A |
| Dispensing 18 | 51 | 100 | 14.3 | 43 | 5 | B |
| Dispensing 19 | 55 | 100 | 13.3 | 42 | 5 | C |
| Dispensing 20 | 52 | 100 | 12.7 | 38 | 5 | D |
| Dispensing 21 | 55 | 100 | 12.2 | 37 | 5 | D |
| Dispensing 22 | 52 | 100 | 13.9 | 43 | 5 | A |
| Dispensing 23 | 51 | 100 | 12.6 | 38 | 5 | B |
| Dispensing 24 | 102 | 200 | 13.0 | 39 | 5 | B |
| Dispensing 25 | 51 | 100 | 14.2 | 43 | 5 | A |
| Dispensing 26 | 90 | 100 | 13.7 | 42 | 12 | D |
| Dispensing 27 | 68 | 100 | 13.1 | 40 | 12 | A |
| Dispensing 28 | 267 | 300 | 14.2 | 43 | 12 | D |
| Dispensing 29 | 66 | 100 | 13.9 | 41 | 12 | A |
| Dispensing 30 | 70 | 100 | 12.5 | 38 | 12 | B |
| Dispensing 31 | 69 | 100 | 12.6 | 38 | 12 | B |
| Dispensing 32 | 75 | 100 | 13.7 | 41 | 12 | C |

Summarizing in a generic formula the calculation of tonₙ, with the direct proportionality bonds as numerator and inverse proportionality bonds as denominator, for the n-th dispensing that falls within a certain type of powder wetting/pre-brewing:

$${ton}_{n} ∝ \frac{{T}_{n} * {G}_{n}}{{\sum }_{i = 1}^{( n - 1 )} ( {v}_{1} / {t}_{i} ) * {\sum }_{i = 1}^{( n - 1 )} ( {T}_{i} / {ton}_{i} )}$$

The control method as conceived herein is susceptible to many modifications and variations, all falling within the scope of the invented concept; furthermore, all the details are replaceable by technically equivalent elements. In practice, the materials used, as well as the dimensions, can be any according to the needs and the state of the art.

1. A control method for controlling the current dispensing cycle of a coffee machine comprising an electronic controller, a brewing pump and a brewing unit having a housing chamber of an amount of coffee powder, in which the current dispensing cycle comprises a dispensing step and a possible preliminary step of wetting said amount of coffee powder in which there is no dispensing, comprising the steps of:
controlling, with the electronic controller, the dispensing speed of the entire dispensing step of the current dispensing cycle comprising, dividing said brewing pump by a control algorithm that acquires a parameter calculated from stored dispensing data of dispensing steps of dispensing cycles preceding the current dispensing cycle exclusively.

2. The control method for controlling the current dispensing cycle of a coffee machine according to claim 1, wherein said control algorithm acquires a piece of data that is representative of the amount of coffee powder used for executing the current brewing cycle.

3. The control method for controlling the current dispensing cycle of a coffee machine according to claim 1, wherein said control algorithm acquires a piece of data that is representative of the type of wetting step used, if provided, for performing the current brewing cycle.

4. The control method for controlling the current dispensing cycle of a coffee machine according to claim 1, wherein said control algorithm calculates at least one of the parameters of a periodic control function comprising a value of the period of said function and an activation time value in said period.

5. The control method for controlling the current dispensing cycle of a coffee machine according to claim 4, wherein said period comprises a sole continuous activation time and a sole continuous deactivation time.

6. The control method for controlling the current dispensing cycle of a coffee machine according to claim 5, wherein an activation at rated power of said brewing pump corresponds to said continuous activation time.

7. The control method for controlling the current dispensing cycle of a coffee machine according to claim 1, wherein said stored dispensing data comprise the duration of the dispensing step of said preceding dispensing cycles.

8. The control method of controlling the current dispensing cycle of a coffee machine according to claim 1, wherein said stored dispensing data comprise the amount of product dispensed in said preceding dispensing cycles.

9. The control method for controlling the current dispensing cycle of a coffee machine according to claim 1, wherein said stored dispensing data comprise the amount of coffee powder used in said preceding dispensing cycles.

10. The control method for controlling the current dispensing cycle of a coffee machine according to claim 4, wherein said stored dispensing data comprise said parameters of said control function calculated in said preceding dispensing cycles.

11. The control method for controlling the current dispensing cycle of a coffee machine according to claim 1, wherein once the type of preliminary wetting step (A, B, C, D) and the amount of coffee powder for the current dispensing cycle are determined, the pump activation time in the current dispensing cycle is directly proportional to the amount of coffee powder of the beverage in the current dispensing cycle and inversely proportional to the average dispensing speed of preceding dispensing cycles weighed on the basis of the division thereof, said preceding cycles relating to the same type of wetting (A, B, C, or D) and to the same amount of powder as the current dispensing cycle.

12. An automatic coffee machine comprising,
an electronic controller provided with a non-volatile memory unit,
a brewing pump, and
a brewing unit comprising a housing chamber of an amount of coffee powder,
wherein said non-volatile memory is configured to store dispensing data of dispensing steps of dispensing cycles preceding a current dispensing cycle and a control algorithm, and
wherein said electronic controller is configured to calculate the dispensing speed of the entire dispensing step of said current dispensing cycle by dividing said brewing pump by said control algorithm that acquires a parameter calculated from said stored dispensing data of dispensing steps of dispensing cycles exclusively preceding said current dispensing cycle.
